(19) United States
(12) Patent Application Publication
(10) Pub. No.: US 2014/0020486 A1
(43) Pub. Date: Jan. 23, 2014

(54) TEST BENCH

(71) Applicant: YONG-SHENG YANG, Shenzhen City (CN)

(72) Inventor: YONG-SHENG YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/569,196

(22) Filed: Aug. 8, 2012

(30) Foreign Application Priority Data
Jul. 17, 2012 (CN) 2012102466539

(51) Int. Cl. G01N 37/00

(52) U.S. Cl. 73/865.9

(57) ABSTRACT

A test bench includes a supporting member, a hollow and columnar first surrounding wall, and a second surrounding wall surrounding the first surrounding wall. The first surrounding wall is lower than the second surrounding wall, and defines an annular groove in a top surface. The supporting member includes a round main portion and an annular extension portion mounted to a circumference of the main portion. A clearance communicating with the groove is defined between a circumference of the extension portion and the second surrounding wall.

### CROSS-REFERENCE TO RELATED APPLICATION

Relevant subject matter is disclosed in a pending U.S. patent application, titled “TEST PLATFORM”, filed on Aug. 6, 2012, with the application Ser. No. 13/568,112, which is assigned to the same assignee as this patent application.

### BACKGROUND

1. Technical Field

The present disclosure relates to a test bench.

2. Description of Related Art

In testing electromagnetic compatibility (EMC), the items to be tested are supported on a round stage. The stage is rotatably mounted in a surrounding wall. A clearance is defined between the stage and the surrounding wall. Copper nets are sandwiched between the stage and the surrounding wall to prevent electromagnetic radiation generated inside the surrounding wall from leaking out and influencing the EMC test. However, the clearance easily trapped with dirt which may scrub the stage when the stage is rotated. Therefore, electromagnetic radiation may be generated and influences the EMC test, which is undesirable.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partly exploded, isometric view of an exemplary embodiment of a test bench.

FIG. 2 is another partly exploded, isometric view of the test bench of FIG. 1.

FIG. 3 is a cross-sectional view of FIG. 1, taken along the line

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

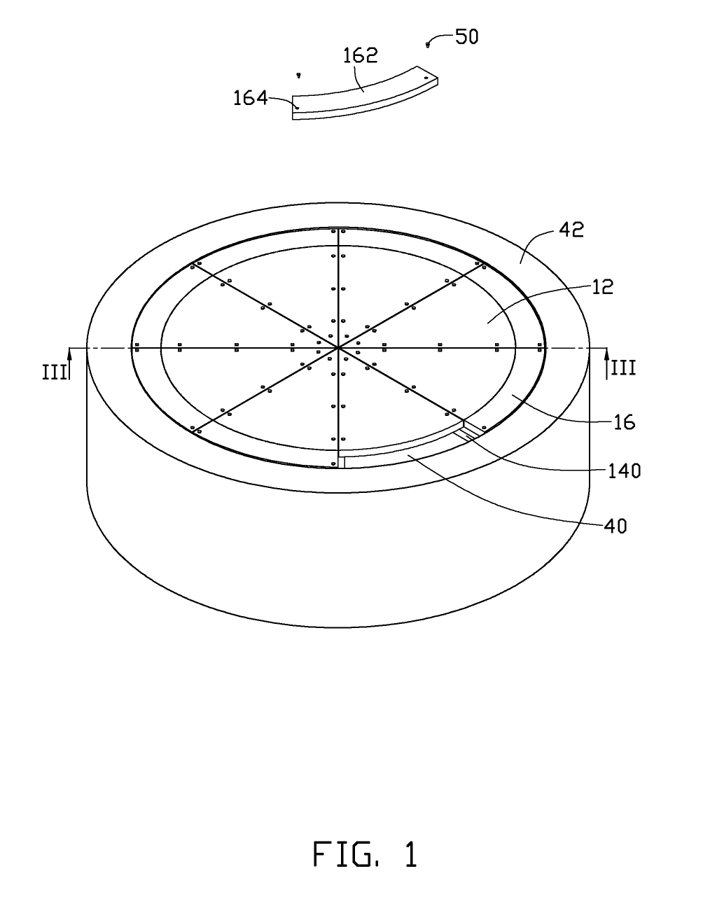

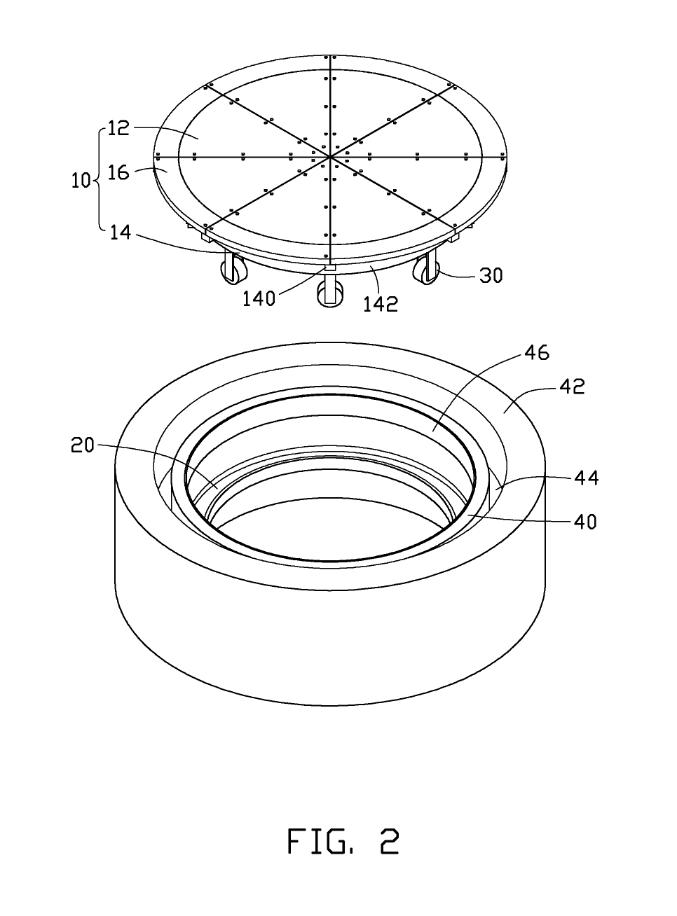

Referring to FIG. 1 and FIG. 2, an exemplary embodiment of a test bench for supporting an object to be tested includes a hollow and columnar first surrounding wall 40, a second surrounding wall 42 surrounding the first surrounding wall 40, and a supporting member 10.

The first surrounding wall 40 is lower than the second surrounding wall 42, and defines an annular groove 44 in a top surface and adjacent to the second surrounding wall 42. A circle of copper net 46 is formed on an upper portion of an inner surface of the first surrounding wall 40. An annular rail 20 protrudes from the inner surface of the first surrounding wall 40, below the copper net 46.

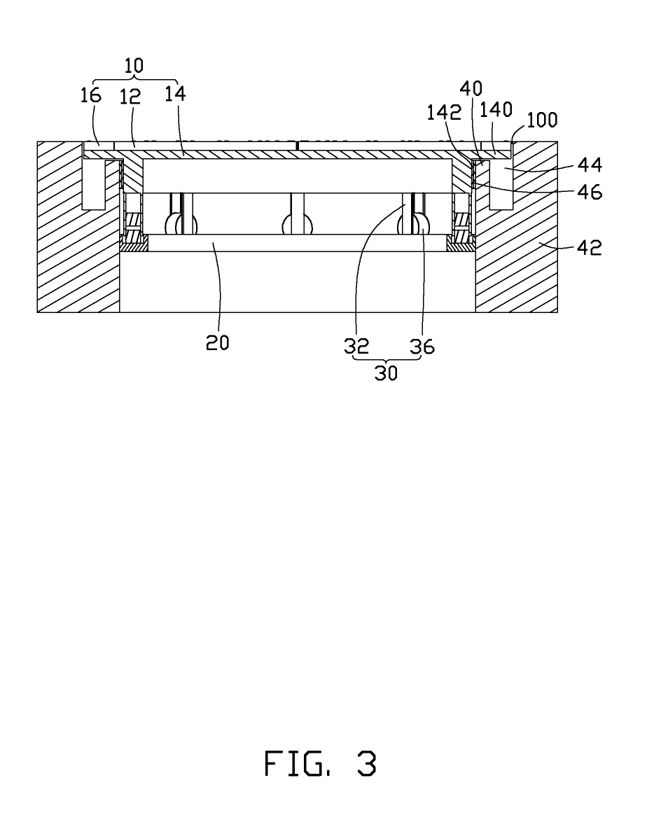

Referring to FIG. 3, the supporting member 10 includes a round main portion 12, a columnar holding portion 14 connected to a bottom of the main portion 12, and an annular extension portion 16. The diameter of the main portion 12 is greater than the holding portion 14. A plurality of plates 140 radially extend from an upper portion of a circumference of the holding portion 14. A circle of copper net 142 is formed on the circumference of the holding portion 14, below the plates 140. The extension portion 16 includes a plurality of curved pieces 162 each defining two fixing holes 164 in opposite ends. A plurality of wheel members 30 is mounted to a bottom of the holding portion 14 opposite to the supporting member 10. Each wheel member 40 includes two arms 32 perpendicularly extending down from the holding portion 14 and a wheel 36 rotatably mounted between bottom ends of the arms 32 opposite to the holding portion 14. The wheels 36 are rested on the rails 20 and capable of rolling along the rail 20 to rotate the supporting member 10.

In assembly, the holding portion 14 is received inside the first surrounding wall 40. The copper net 142 is movably contacted the copper net 46. The plates 140 are located upon the top surface of the first surrounding wall 40. Two fasteners 50 extend through the fixing holes 164 of each curved piece 162 and engage in two adjacent plates 140, to fix the curved piece 162 to the two adjacent plates 140. A clearance 100 communicating with the groove 44 is defined between the extension portion 16 and the second surrounding wall 42.

In use, dirt got in through the clearance 100 will fall into the groove 44. In cleaning the groove 44, the fasteners 50 are released to disengage the extension pieces 162 from the plates 140, thereby the groove 44 is exposed and readily to be cleaned.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A test bench, comprising:
a supporting member comprising a round main portion and an annular extension portion detachably mounted to a circumference of the main portion;
a hollow and columnar first surrounding wall supporting the supporting member, and defining an annular groove in a top surface; and
a second surrounding wall surrounding the first surrounding wall and higher than the first surrounding wall;
wherein a clearance communicating with the groove is defined between the extension portion and the second surrounding wall, dirt got in through the clearance will fall into the groove.

2. The test bench of claim 1, wherein an annular rail protrudes from an inner surface of the first surrounding wall, the supporting member further comprises a plurality of wheel members mounted to a bottom of the main portion, each wheel member comprises a wheel rested on the rail and capable of rolling along the rail.

3. The test bench of claim 1, wherein the supporting member further comprises a columnar holding portion connected to a bottom of the main portion, a diameter of the holding portion is greater than a diameter of the main portion, a circle of copper net is formed on each of a circumference of the holding portion and the inner surface of the first surrounding wall.

4. The test bench of claim 1, wherein the supporting member further comprises a columnar holding portion connected to a bottom of the main portion, a diameter of the holding portion is greater than a diameter of the main portion, a plurality of plates radially extends from the circumference of the holding portion, and is located upon the top surface of the first surrounding wall, the extension portion is detachably fixed to the plates.

5. The test bench of claim 4, wherein the extension portion comprises a plurality of curved pieces, opposite ends of each curved piece is detachably mounted to two adjacent plates.
